(19) United States
(12) Patent Application Publication
(10) Pub. No.: US 2011/0073572 A1
(43) Pub. Date: Mar. 31, 2011

(54) METHOD TO REDUCE THERMAL DEGRADATION OF ADHESIVE IN WELDBONDING

(75) Inventors: Pei-Chung Wang, Shanghai (CN); Samuel P. Marin, Silver Spring, MD (US); Sheila A. Marin, Silver Spring, MD (US); Peter C. Sun, Shanghai (CN)

(73) Assignee: GM GLOBAL TECHNOLOGY OPERATIONS, INC., Detroit, MI (US)

(21) Appl. No.: 12/835,873

(22) Filed: Jul. 14, 2010

(30) Foreign Application Priority Data
Sep. 25, 2009 (DE) 102009042973

(51) Int. Cl. B23K 11/10; B23K 11/00; B23K 20/12

(52) U.S. Cl. 219/91.2; 219/117.1; 228/112.1

(57) ABSTRACT

A method for weldbonding together metal sheets includes applying adhesive on the surface of a first sheet and placing a second sheet atop the first sheet. The sheets are heated at a selected location to a high temperature forming a metallic weld nugget between the first sheet and the second sheet. The adhesive may be a heat curable adhesive that is cured by the heat, or the adhesive may be heated at ambient temperatures. One or both of the sheets is then cooled in the area surrounding the selected location of heating so that the high temperature needed to created the metallic weld nugget is prevented from transferring so far beyond the selected location as to overheat the adhesive layer and thereby degrade the quality of the adhesive bond.

This application claims priority from German Patent Application 102009042973 filed Sep. 25, 2009.

### FIELD OF THE INVENTION

The present invention relates to a method to reduce the thermal degradation of the adhesive used in the weldbonding of metal sheets.

### BACKGROUND OF THE INVENTION

It is known to place a polymer adhesive or sealant between two sheets and then attach the sheet together by applying electric current via resistance weld electrodes to create an electric resistance spot weld and simultaneously heat the sheets. In some cases the heat can cure the adhesive. Or the adhesive may have been cured previously at ambient temperature. The spot weld and the adhesive bond each contribute to a high strength attachment between the metal plates. However, the temperature required to create the metal-to-metal weld is much higher than the temperature the adhesive can sustain and therefore can result in a large area of degradation of the adhesive bond caused by overheating of the adhesive. In order to compensate for the degradation, the welds must be placed farther apart or larger amounts of adhesive must be used, thus increasing the cost and complexity of weldbonding applications.

### SUMMARY OF THE INVENTION

A method for weldbonding together metal sheets includes applying adhesive on the surface of a first sheet and placing a second sheet atop the first sheet. The sheets are heated at a selected location to a high temperature forming a metallic weld nugget between the first sheet and the second sheet. The heating of the sheets also heats the adhesive. One or both of the sheets is then cooled in the area surrounding the selected location of heating so that the high temperature needed to create the metallic weld nugget is prevented from transferring so far beyond the selected location as to overheat the adhesive layer and thereby degrade the quality of the adhesive bond.

### BRIEF DESCRIPTION OF THE DRAWINGS

The present invention will become more fully understood from the detailed description and the accompanying drawings, wherein:

FIG. 1 is an elevation view taken in section showing two metal sheets with a layer of adhesive between the metal sheets.

FIG. 2 is a side elevation view of weld electrodes applied to the metal sheets.

FIG. 3 is a section view taken in the direction of arrows 3-3 of FIG. 2.

FIG. 4 is a perspective view having parts broken away and in section and showing a second embodiment of the invention.

FIG. 5 is a perspective view having parts broken away and in section and showing a third embodiment of the invention.

### DETAILED DESCRIPTION OF THE EXEMPLARY EMBODIMENTS

The following description of certain exemplary embodiments is merely exemplary in nature and is not intended to limit the invention, its application, or uses.

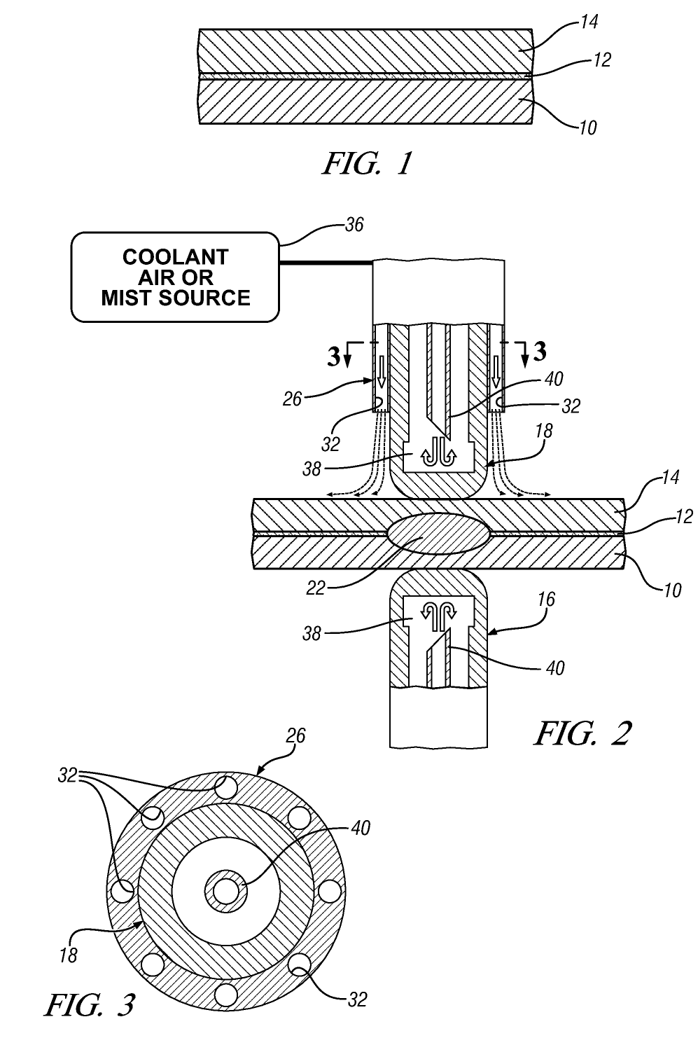

Referring to FIG. 1, a first metal sheet 10 is coated with a heat adhesive 12 and then a second metal sheet 14 is placed atop the adhesive 12.

In FIG. 2, a weld-making tool Includes a first or lower electric resistance spot welding electrode 16 and a second or upper electric resistance spot welding electrode 18. The first spot welding electrode 16 is applied to the first sheet 10 and the second spot welding electrode 18 is applied to the second sheet 14.

Squeeze pressure is applied to the electrodes 16 and 18 and weld current is applied between the first electrode 16 and the second electrode 18 to create a resistance spot weld nugget 22 between the metal of the first sheet 10 and the second sheet 14. The heat created in making the resistance spot weld nugget 22 heats the metal sheets 10 and 14. The adhesive may be a heat curable adhesive that is cured by the heat. Or the adhesive may be curable at ambient temperature.

We have observed that exposing the adhesive 12 to a temperate exceeding about 250 degrees Centigrade will degrade the performance of the adhesive. Because the formation of the resistance spot weld nugget 22 requires the spot heating of the metal sheets 10 and 14 to a temperature of about 1550 degrees Centigrade, in the case of steel sheets, the adhesive will be degraded in a region surrounding the location of the spot weld nugget 22.

Referring to FIGS. 2 and 3, a cooling manifold 26 is mounted on the second electrode 18. The cooling manifold 26 is annular in shape and friction fits onto the second electrode 18. The cooling manifold 26 has a plurality of axial flow passages or nozzles 32 that are connected to a coolant source 36. The coolant source 36 provides a flow of coolant, such as air or a fluid mist or water, or other gas or liquid that flows onto the second sheet 14 in the region surrounding the resistance spot weld nugget 22. The coolant will provide cooling of the metal sheet 14 and therefore reduce the size of the region of degradation of adhesive 12 that would otherwise occur around the electrodes. It will be understood that the flow rate and temperature and duration, as well as the heat dissipating characteristics of the particular coolant, will determine the extent to which the cooling and reduction in degradation is achieved. Thus with proper selection of coolant flow and by properly locating the flow onto the surface of the metal, the temperature can be controlled in a manner which is conducive to forming of the resistance weld and also achieving a high quality adhesive bond. Although there will be a region of adhesive degradation directly surrounding the resistance weld this region of degradation will be minimized and the region of undegraded adhesive bonding can be maximized. For example, in a typical application, the weld current can be conducted in order to heat the sheets, and then after a slight delay, the coolant flow can be initiated to begin a cooling of the sheets so that the propagation of heat into the sheets is controlled in a manner to properly make the metal-to-metal electric resistance weld, and yet the sheets are not unnecessarily overheated in a manner that would degrade the adhesive over a larger than necessary region. The electrodes 16 and 18 can remain in contact with the metal sheets 10 and 14 during the coolant flow, or the electrodes can be lifted out of contact but remain poised over the weld during an additional period of coolant flow as needed to achieve the optimum cooling of the sheets 10 and 14 to achieve optimum weldbonding.

In addition, FIGS. 2 and 3 show that each of the electrodes 16 and 18 have an internal cooling chamber 38 that receives coolant through a pipe 40 to control the temperature of the electrodes. This cooling of the electrodes 16 and 18 contributes to the reduction in degradation provided by the flow from the cooling manifold 26. The coolant provided by the pipe 40 is preferably a liquid, but can also come from the coolant source 36.

It will be understood that a cooling manifold similar to the cooling manifold 26 can also be provided on the first electrode 16 to cool the first sheet 10. In addition, the cooling manifold can be mounted on the electrode as shown in the drawings, or alternatively, the cooling manifold can be mounted on the electrode holder or other structure of the welding apparatus. In addition it will be understood that the electrodes will be moved along the sheets to make a series of such metal weld nuggets.

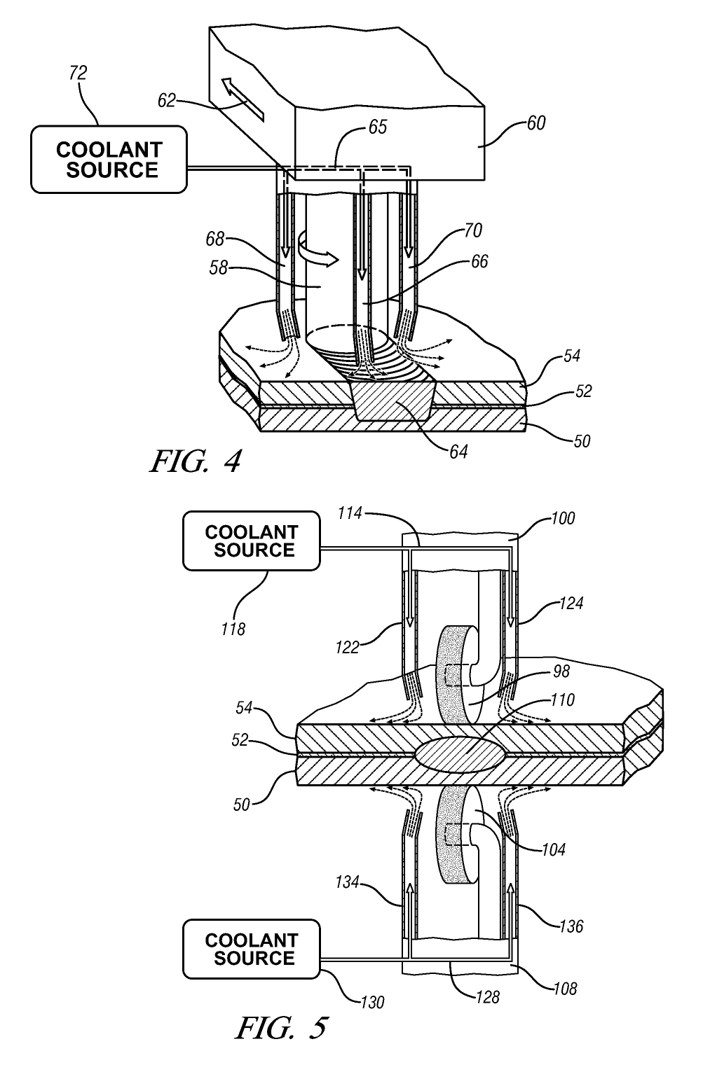

FIG. 4 shows another embodiment of the invention. In FIG. 4, a first metal sheet 50 is coated with adhesive 52 and then a second metal sheet 54 is placed atop the adhesive 52. In FIG. 4 the weld-making tool is a friction stir welding tool 58 that is mounted within a tool holder 60 and is rotating at high speed. The tool 58 has been plunged into the first metal sheet 50 and the second metal sheet 54 and is traversing a path along the sheets in the direction of arrow 62. The high speed rotation of the tool 58 softens and stirs the metal of the sheets 50 and 54 to create a continuous weld nugget 64 that permanently attaches together the metal sheets 50 and 54. In addition, the heat created by the friction stir welding will heat the metal sheets 50 and 54 and the adhesive 52.

A cooling manifold 65 is mounted on the tool holder 60 and includes a nozzles 66, 68 and nozzle 70 that are connected to a coolant source 72. The coolant source 72 provides a flow of coolant, such as air or a fluid mist or water that flows onto the second metal sheet 54 in the region alongside and following the friction stir weld nugget 64. The coolant will provide cooling of the metal sheet 54 and therefore reduce the size of the region of degradation of adhesive 52 that would otherwise occur around the weld nugget 64. It will be understood that the flow rate and temperature and duration, as well as the heat dissipating characteristics of the particular coolant, will determine the extent to which the cooling and reduction in degradation is achieved. FIG. 4 also shows the nozzle 66 positioned behind the tool 58 so that the nozzle 66 follows along behind the tool 58 as the tool 58 moves in the direction of arrow 62 and the weld nugget 64 is cooled after its creation. The nozzles 68 and 70 are positioned along the left and right side of the path of the movement of the tool 58. Any number of such nozzles can direct the coolant flow onto the metal sheets at a selected distance from the weld tool 58, or only in a path following behind the weld tool 58, with the number and location of the nozzles chosen so that cooling provided by the coolant does not adversely affect the heating of the sheets that is required to achieve the friction stirring of the metal sheets and yet will optimize the cooling of the sheets to minimize the degradation of the adhesive bond.

FIG. 5 shows another embodiment of the invention. In FIG. 5, a first metal sheet 90 is coated with adhesive 92 and then a second metal sheet 94 is placed atop the adhesive 92. A first electrode roller 98 is carried by a tool holder 100 and is pressed against the second metal sheet 94. A second electrode roller 104 is carried by a tool holder 108 and is pressed against the first metal sheet 90. The electrode rollers 98 and 104 roll along the metal sheets 90 and 94, which can be accomplished either by moving the tools holders 100 and 108 along the sheets, or by moving the sheets 90 and 94 between the electrode rollers 98 and 104. Weld current is conducted between the first electrode roller 98 and the second electrode roller 104 to create a weld nugget 110 that extends in a continuous path within the first sheet 90 and the second sheet 94. The heat created in making the resistance weld nugget 110 simultaneously heats the metal sheets 90 and 94 and the adhesive 92.

A cooling manifold 114 is mounted on the tool holder 100 and is connected to of a coolant source 118. A plurality of nozzles, shown for example at 122 and 124 are mounted on the tool holder 100 and are connected with the cooling manifold 114 to provide a flow of coolant, such as air or a fluid mist or water that flows onto the metal sheet 94 in the region alongside and following the electrode roller 98. Likewise, a cooling manifold 128 is mounted on the tool holder 108 and connects with a coolant source 130 and nozzles 134 and 136 to spray coolant onto the metal sheet 90. The coolant will provide cooling of the metal sheets 90 and 94 and therefore reduce the size of the region of degradation of adhesive 92 that would otherwise occur around continuous weld nugget 110. It will be understood that the flow rate and temperature and duration, as well as the heat dissipating characteristics of the particular coolant, will determine the extent to which the cooling and reduction in degradation is achieved.

Thus it is seen that the invention will optimize weldbonding of metal sheets by allowing the creation of high temperature to make the metal-to-metal weld nugget, and yet control the metal temperatures to achieve optimal heating without excessive adhesive degradation.

Although the drawings show the example of two metal sheets being weldbonded together, the aforedescribed weldbonding method can be used when two or three or more sheets are being attached together. In addition, rather than simple metal sheets, one or both of the metal sheets can be a laminated metal of metal-polymer-metal construction, and the coolant flow will minimize the possibility that the heating will degrade the polymer layer of the laminated metal.

What is claimed is:

1. A method for weldbonding together metal sheets comprising:
applying adhesive on the surface of a first sheet;
placing a second sheet against the first sheet;
heating of the sheets at a selected location to a temperature forming a metallic weld nugget between the first sheet and the second sheet; said heating of the sheets also heating the adhesive;
and cooling one or both of the sheets in the area surrounding the selected location of heating such that the high temperature needed to create the metallic weld nugget is prevented from transferring so far beyond the selected location as to overheat the adhesive layer and thereby degrade the quality of the adhesive bond.

2. The method of claim 1 further comprising said heating of the sheets being performed by applying a weld-making tool against at least one of the metal sheets.

3. The method of claim 2 further comprising the weld-making tool being an electric resistance weld electrode and electrical current being conducted through the metal sheets.

4. The method of claim 2 further comprising the weld-making tool being a friction stir welding tool that rotates at a high speed and heats the metal sheets by friction.

5. The method of claim 1 further comprising said heating of the sheets being performed by applying a weld making tool against each of the first and second metal sheets.

6. The method of claim 5 further comprising the weld-making tool being first and second spot welding electrodes applied respectively against the first and second metal sheets and electrical current being conducted through the electrodes to make an electric resistance spot weld.

7. The method of claim 5 further comprising the weld-making tool being first and second electrode rollers applied respectively to the first and second sheets and the rollers traversing a path along the sheets and electrical current being conducted through the rollers to make a continuous electric resistance weld seam.

8. The method of claim 1 further comprising the cooling being provided by coolant being sprayed onto the surface of at least one of the metal sheets.

9. The method of claim 8 further comprising one or more nozzles connected to a source of coolant and spraying the coolant.

10. The method of claim 8 further comprising a weld making tool mounted on a tool holder and a plurality of nozzles mounted on the tool holder and connected to a source of coolant to spray the coolant onto the at least one metal sheet.

11. The method of claim 8 further comprising the metal sheets being heated by a weld making tool that is mounted on a tool holder that progressively applies the weld making tool to the metal sheets along a path to create either a continuous weld nugget or a series of spot weld nuggets and at least one spray nozzle is mounted on the tool holder to follow behind or alongside the path to cool the metal sheets.

12. The method of claim 1 further comprising heating the sheets to approximately 1550 degrees Centigrade to create the weld nugget and then cooling the sheets so that a region of the adhesive does not exceed a temperature of 250 degrees Centigrade to assure creation of an adhesive bond that is not degraded by excessive temperature.

13. A method for weldbonding together metal sheets comprising:
applying heat curable adhesive on the surface of a first sheet;
placing a second sheet against the first sheet;
applying a first electrode to the first sheet and a second electrode to the second sheet;
conducting weld current between the first and second electrodes to create an electric resistance spot weld between the metal of the first and second sheets and simultaneously heat the metal to cure the heat curable adhesive;
and spraying air or a mist onto one or both of the sheets in the area surrounding one or both of the electrodes to cool the sheets sufficient to prevent degradation of the adhesive.

14. The method of claim 13 further comprising the first and second electrodes being first and second spot welding electrodes.

15. The method of claim 13 further comprising the first and second electrodes being mounted on first and second tool holders and coolant spray nozzles mounted on the first and second tool holders.

16. The method of claim 15 further comprising the tool holders traversing a path along the metal sheets to make a series of spot welds and the coolant spray nozzles are positioned to spray onto the metal sheets surrounding the spot welds and after the spot welds are made.

17. The method of claim 13 further comprising the first and second electrodes being first and second electrodes rollers.

18. The method of claim 17 further comprising the first an second electrodes being mounted on first and second tool holders and spray nozzles being mounted on the first and second tool holders to spray a coolant onto the metal sheets as the rollers progress along a path of contact with the metal sheets.

19. A method for weldbonding together metal sheets comprising:
applying heat curable adhesive on the surface of a first sheet;
placing a second sheet against the first sheet;
plunging a high speed rotating tool into the metal sheets to create a friction stirring of the metal and formation of a metal weld nugget, said heating of the sheets also curing the adhesive to adhesively bond the sheets;
and spraying a gas or liquid coolant onto one or both of the sheets to thereby cool the sheets such that the high temperature needed to created the weld nugget is prevented from transferring so far into the adhesive as to overheat the adhesive layer and thereby degrade the quality of the adhesive bond.

20. The method of claim 19 further comprising the rotating tool being mounted on a tool holder and a plurality of spray nozzles are mounted on the tools holder to spray the coolant onto at least one of the sheets.
